(19) United States
(12) Patent Application Publication
(10) Pub. No.: US 2018/0358683 A1
(43) Pub. Date: Dec. 13, 2018

(54) HIGH-FREQUENCY AND WIDEBAND ANTENNA COMPRISING CONNECTION CONTROLLING MEANS

(71) Applicant: AGC GLASS EUROPE, Louvain-La-Neuve (BE)

(72) Inventors: Remi SARKIS, Louvain-La-Neuve (BE); Dan LIS, Isnes (BE)

(73) Assignee: AGC GLASS EUROPE, Louvain-La-Neuve (BE)

(21) Appl. No.: 15/779,134

(22) PCT Filed: Nov. 24, 2016
(86) PCT No.: PCT/EP2016/078620

§ 371 Date: May 25, 2018

(30) Foreign Application Priority Data
Nov. 27, 2015 (EP) 15196652.0

(51) Int. Cl. H01Q 1/12; H01R 24/50; H01R 9/05

(52) U.S. Cl. CPC H01Q 1/1271; H01R 24/50; H01R 2103/00; H01R 2201/02; H01R 9/0518

(57) ABSTRACT

The invention concerns a wideband antenna connected to a coaxial cable further comprising means for controlling the electrical link between the antenna and the cable.

### 1. TECHNICAL DOMAIN OF THE INVENTION

The present invention relates to buildings or vehicles, which comprise glazing panels with an antenna printed thereon for radio communication, with receivers or transmitters outside or associated with these buildings or vehicles, by means of personal cellular radio terminals. These antennas are components of all kinds of equipment using radio waves, such as radio broadcasting systems, broadcast television systems, radars, cell phone terminals, satellite communication systems and other garage or car door openers, wireless microphones, Bluetooth-enabled devices, wireless computer networks or RFLD tags on merchandise.

The present invention relates more particularly to high frequency (HF) and wideband (WB) communication. Unlike low frequency communication, which can make use of wire antennas, like the heating wires printed on the backlite of cars, connected to standard data transmission lines, HF and WB communication requires two part bidimensional antennas with data transmission coaxial cables.

The antennas here of concern are mainly provided as long term evolution (LTE) antennas, namely for mobile internet and 4 G cellular telephone networks.

The two parts of these antennas are connected to the central pin and the shield of the coaxial cable, respectively.

They can be made of an alloy of silver and copper to be printed on glass or plastic.

However, the correct connection of the feeding element to the antenna is still a particularly sensitive issue to solve, especially in the case of lead-free soldering, since, depending on the chosen lead-free alternative, there is the risk to alter the substrate, which is problematic for wideband antenna, or to exhibit poor cohesive strength, which is not acceptable. In other words, the incorporation of a wideband antenna into a glazing panel at an industrial scale and/or involving automated tasks is not possible using the current approaches.

The present invention aims to solve this problem.

To this end, the present invention relates to an assembly of a long term evolution two part bidimensional antenna for HF and WB communication, a data transmission coaxial cable with a central pin and a shield, and means for connecting the central pin and the shield of the cable to the two parts of the antenna, the two parts of the antenna being printed on a glazing panel, characterized in that it further comprises an electrical component chosen amongst the group consisting of a resistor, a capacitor and an inductance, bridging the two parts of the antenna for controlling the connection between the cable and the antenna.

This new combination allows firstly a better integration of the wideband antenna to glazing panels that are designed to be incorporated into cars or buildings.

In order to check if the central pin and the shield of the coaxial cable are properly connected to the two parts of the antenna, which are in a conductive material, these two parts are bridged by the control component, which is preferably a resistor, and the resistance between the shield and the central pin of the coaxial cable is measured, but with direct current and not radio frequency current. Under these circumstances, the current should flow through the central pin, the antenna part to which the central pin should be connected, the control resistor, the antenna part to which the shield should be connected and the shield of the coaxial cable. In case of a lack of connection, the resistor measuring device will not see the control resistor, but an infinite resistor.

Therefore, a closely related aspect of the present invention is the use of an electric component for controlling the electric connection of a coaxial cable to a wideband antenna.

The invention also relates to the intermediate assembly comprising a long term evolution two part bidimensional antenna for HF and WB communication, to be connected to a data transmission coaxial cable, with a central pin and a shield to be connected to the two parts of the antenna, the two parts of the antenna being printed on a glazing panel, characterized in that it further comprises an electrical component chosen amongst the group consisting of a resistor, a capacitor and an inductance, bridging the two parts of the antenna for controlling the connection between the cable and the antenna.

According to one embodiment of the present invention, the electrical component may be a resistor or a capacitor or an inductance or an assembly comprising a resistor and a capacitor or a resistor and an inductance or a capacitor and an inductance or an assembly comprising a resistor, a capacitor and an inductance.

### 2. BRIEF DESCRIPTION OF THE DRAWINGS

The invention shall be better understood upon reading the following description with the help of the attached drawings, wherein

FIG. 1 is a plan view of a wideband antenna according to the present invention.

FIG. 2 is a plan view of a preferred wideband antenna.

FIG. 3 is a corresponding side view.

### 3. DETAILED DESCRIPTION OF THE INVENTION

The incorporation of wideband antenna into glazing panels represents a challenge as the antenna should be small enough so as to be placed (e.g. by printing) at non-transparent zones of a glass or non-visible zones of a glass, such as the black print of automobile glasses.

On the other hand, antenna for these high frequencies comprises at least two parts and the connection of the antenna to electric supply involves a coaxial cable. The correct fixing and connection of the element of the dual cable to the elements of the wideband antenna can hardly be automated.

Indeed, the connections must be functional and located precisely. Furthermore, soldering should not affect the antenna geometry. Such achievement is not attainable at an industrial scale, at least in the case of lead-free soldering. In other words, significant losses will be present if the connections are routinely made.

The applicant has identified that incorporation of means for controlling the electrical link between the antenna and the cable allows to detect the malfunction of the assembly due to for example a deteriorated electrical link or a glazing panel breakage.

According to the invention, a glazing panel can be a flat or curved glazing panel to fit with the design of the car or the building wherein the glazing panel will be integrated. The glazing panel can be tempered to respect with the specifications of security. When a glass according to the invention is integrated into a car or a vehicle in general, a heatable system, for example a coating or a network of wires, can be applied on the pane of glass to add a defrosting function for example. Also, the glazing panel can be a clear glass or a colored glass, tinted with a specific composition of the glass or by applying a coating or a plastic layer for example.

According to one preferred embodiment of the present invention, the glazing panel is a glazing for automotive, i.e. windshield, backlite, sidelite or fixed in the carbody, such as roof.

This combination allows scaling up of the fixation of the required elements and of the downstream quality control.

Means for controlling the electrical link between the antenna and the cable is an electric resistance, such as a ceramic material or a bridge of poor electrical conductivity.

By bridge of poor electrical conductivity, it is preferably meant a poorly conductive alloy with less than 5% of silver or copper, such as bronze-based alloys, or any suitable composition that is much less electrically-conductive than silver or copper, but still conducting electricity.

Typical resistances range between 1 kOhm to 10000 kOhm and a resistance of about 100 kOhms is suitable.

The incorporation of means for controlling the electrical link between the antenna and the cable in the form of a resistance allows to control the connection of the elements of the coaxial cable to the segments of the antenna: in case of all the elements are well fixed, Direct Current (DC) can pass through the system, and a resistance is measured. Conversely, in case of defect, for instance an impaired soldering of one of the element or a malfunction between the antenna and the cable, no DC can pass and infinite resistance is measured; then the defective device would be discarded and replaced by a good-one (i.e. into a car or a building).

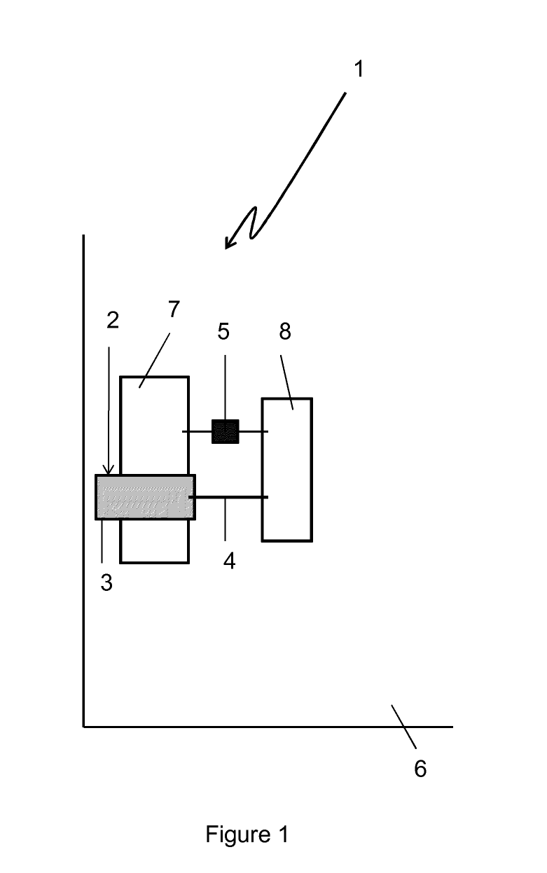

Referring to FIG. 1, a wideband antenna 1, herein a printed antenna such as a printed antenna comprising more than 95% of copper and/or of silver, to be applied on a glass panel 6, comprises two distinct bidimensional elements in the form of a first electrically conductive surface 8 and of a second electrically conductive surface 7. However, the two parts of these antennas may be made in any conductive material suitable for this application. Within the scope of the invention, by “conductive” material it is meant a material that is substantially conductive with a resistivity of less than 10 ohm/squared, preferably less than 5 ohm/squared. This antenna 1, in operation, is connected to a coaxial cable 2, which comprises a central pin 4 and a shield 3 separated by a dielectric element, wherein the central pin 4 is soldered (e.g. lead-free) to the first surface 8 so as to allow electric current to pass and the shield of the coaxial cable 2 is in electric connection to the second surface 7. Electrical component 5 (here a resistor) for controlling the electrical link between the antenna and the cable.

According to one embodiment of the present invention, the electrical component 5 may comprise a resistor, a capacitor and an inductance, or a capacitor or a capacitor and an inductance or an inductance, provided onto a glazing panel and particularly a glazing panel comprising at least one glass sheet to which it is connected.

According to another embodiment of the present invention, the electrical component is printed onto a glazing panel and particularly a glazing panel comprising at least one glass sheet to which it is connected. In a preferred embodiment, the electrical component 5 is printed by serigraphy or by ink-jet onto the glazing panel.

Thus, in case of both the electrical component 5 and the two parts of the antenna (7, 8) are printed by serigraphy, the two parts of the antenna are printed by serigraphy onto the glazing panel with a first mask and the electrical component is printed by serigraphy onto the two parts of the antenna with a second mask. Thus, two types of components (antenna and electrical component) may be printed onto the glazing panel leading to simplifying of the process for making the assembly according to the invention.

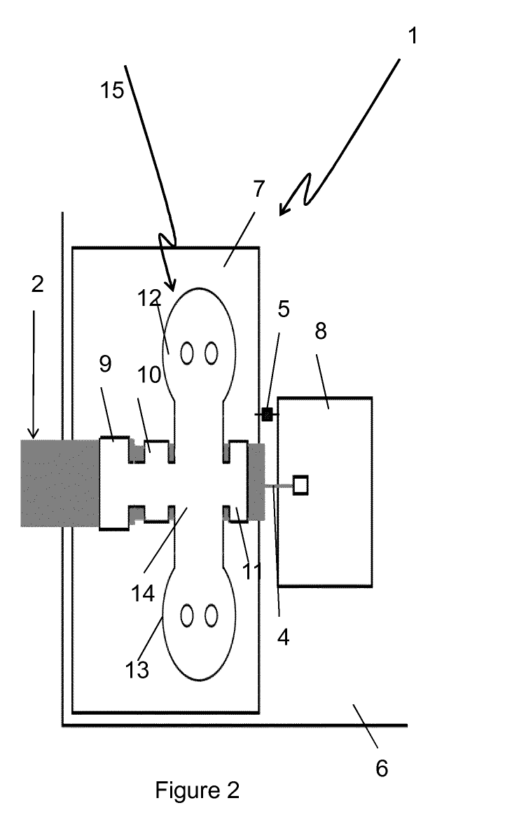

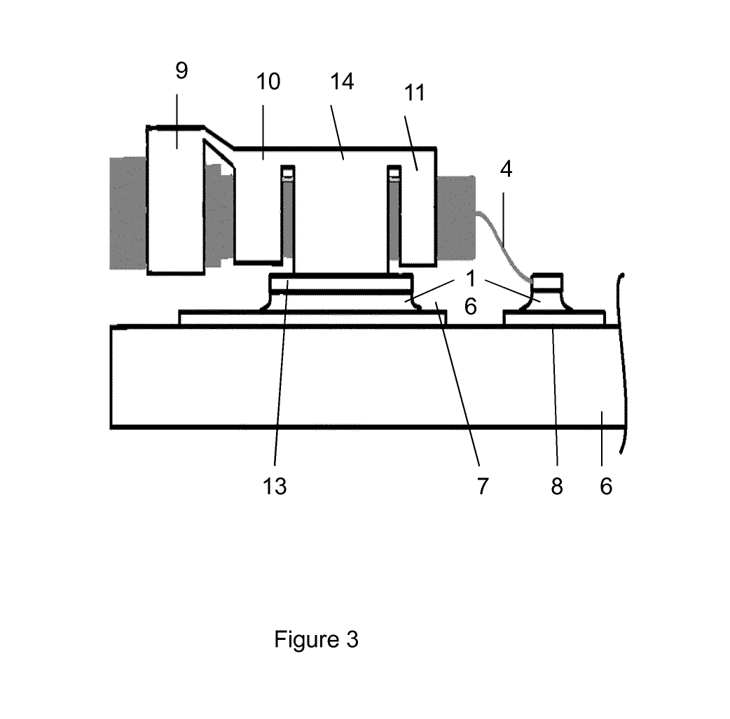

As shown in FIGS. 2 and 3, an electrically conductive connector 15 comprising two feet 12, 13 and a U-shaped region 14 may further be electrically connected to the first part of the antenna 7 through a soldering material 16 and to the shield of the coaxial cable 3, so as to allow a more reliable connection between the coaxial cable 3 and the antenna 7.

This allows an easier fixation and a better electricity transfer between the cable and the antenna.

Three U-shaped mechanical fixing elements 9, 10, 11 may further be added so as to fasten the cable 2 to the antenna.

These elements allow to avoid movements of the cable and further ensures a good electrical connection.

According to one embodiment of the present invention, the coaxial cable is a cable designed to allow carrying higher frequency signals better than a cable used for automotive antenna placed on glass and comprises at least a pin and a shield separated by a dielectric element and protected by an insulated layer.

According to one preferred embodiment of the present invention, the electrically conductive connector connects an antenna to the cable and is joined to the antenna by a lead-free soldering to respect the new European regulation.

The electrically conductive connector material is preferably a material selected to have difference of thermal expansion of the glazing panel and the electrically conductive connector material less than 5×10−6/° C.

According to the invention, the connector may be made of different types of material such as Copper, Chromium alloys, Steel alloys such stainless steel alloys, steel alloys with a high amount of Chromium or Nickel or any other materials or alloys that fit with constraints of the connector functions such as to be connected to an antenna, to be able to fix a cable, and other advantages of this kind of materials or alloys.

Preferably, the solder material has improved properties at temperatures greater than 150° C. Such a solder material is known from DE102006047764A1. Such a lead-free solder material is based on a solder alloy of Sn, Ag, comprising between 88% and 98.5% Sn by weight, between 0.5 and 5% Ag by weight or Bismuth-Tin-Silver (Bi—Sn—Ag) alloys. Preferably, the soldering material comprises the following alloys, at least as components thereof BixSnyAgz where x, y, z represents the percentage by weight of the component (this nomenclature is well-known): Bi57Sn42Ag0, Bi57Sn40Ag3, SnAg3.8Cu0.7, Sn55Bi44Ag1, or SAC alloys (Tin-Silver-Copper (Sn—Ag—Cu) alloys). More preferably, the solder alloy is a SAC305, consisting of 3% Ag by weight, 0.5% Cu by weight and 96.5% Sn by weight. This solder material offers improved bonding properties for the connectors used therewith, as well as high fatigue strength.

According to the invention, the connector element preferably is made of an iron-nickel (FeNi) or iron-chromium (FeCr) alloys, or a mixture thereof. More preferably, the connector element is preferably made of FeCr10, FeCr16, a Grade 430, FeNi42, FeNi48 or FeNi52.

Due to the high frequency used, the connection between the antenna and the cable has to be very precise to limit the distortion of the signal. In order to fulfill this condition, the connector comprises at least two mechanical fixing elements. These mechanical fixing elements allow maintaining the cable in the right place avoiding movements of the cable and ensure having a good electrical connection to the antenna. These elements may have a different composition than the connector. Preferably, the shield is connected to the antenna via at least one of the mechanical fixing element to have a very good electrical connection to the antenna.

According to the invention, the central pin is preferably connected to the antenna by a lead-free soldering separately from the electrically conductive connector. The central pin may be preferably crimped into an intermediate conductive element. In this case, the lead-free solder material is provided between the intermediate element and the antenna.

According to one embodiment of the invention, the electrically conductive connector preferably comprises at least an extended region for fixing mechanical fixing elements and at least one foot connected to the extended region for joining to the antenna by a lead-free solder material Those two parts meaning at least one foot and an extended region allow to facilitate the soldering of the connector to the antenna and the fixing of the cable. According to the invention, the extended region is the region that is not directly in contact with the antenna but electrically connected to the antenna through the foot. Preferably, the shape of the extended region may be a rectangular part, curved or not, or any other shapes. The foot is in contact with the antenna through the solder material. Preferably, the electrically conductive connector comprises at least one foot with a rounded shape. It is understood that the rounded shape term means any form with a general rounded shape like, in a non-limiting manner, an oval shape, an ovoid shape, an circle shape, a semi-circle shape, a clover shape, a multi-circles shape, a polyhedron like for example a part of a circle with cut edges, or a rectangular shape with rounded edges, like a rectangular with rounded corners. It could also be a single ring shape.

More preferably, the electrically conductive connector comprises two feet to have stability during the process of mounting the connector on the antenna and to stabilize the cable during the life-time of the glazing panel by avoiding any movement of the cable.

According to the invention, the electrically conductive connector comprises at least a part of the extended region provided between feet. When an at least a part of the extended region provided between feet, the shape of the extended region is a U-shape or a T-shape. A U-shape means a kind of bridge connecting the two feet. A T-shape means a kind of a bridge with a substantially perpendicular portion. The advantage of this kind of shapes is to have a symmetrical connector with a high stability.

According to the invention, mechanical fixing elements are provided to maintain the cable to the connector. They are preferably fixed to the extended region. Preferably, mechanical fixing elements are crimping elements to crimp the cable to the connector in order to reduce the process timing and avoid movement of the cable after the crimping step.

Preferably, mechanical fixing elements have the same composition than the extended region and may have been manufactured in the same piece than the extended region.

More preferably, to avoid deformation of the extended region due to the mechanical fixing of the cable, mechanical fixing elements are fixed to at least one edge of the extended region of the electrically conductive connector.

More preferably, to eliminate any fluctuation of behavior due to unstable coaxial cable connection with the extended region, mechanical fixing elements are fixed to opposite edge of the extended region of the electrically conductive connector.

In one embodiment of the present invention, the electrically conductive connector comprises three mechanical fixing elements; two of the mechanical fixing elements are electrically connected to the shield of the coaxial cable and are fixed to opposite edge of the extended region of the electrically conductive connector and one of the mechanical fixing elements is fixed to the insulated layer of the coaxial. This feature allows to ensure the electrical connectivity and to eliminate any fluctuation of behavior due to unstable coaxial cable connection with the extended region.

The present invention relates also to a connector comprising at least two mechanical fixing elements for maintaining the coaxial cable to the electrically conductive connector.

According to the invention, the connector preferably comprises at least an extended region for fixing mechanical fixing elements and one foot connected to the extended region for joining to the antenna by a lead-free solder.

According to the invention, the connector preferably comprises two feet.

According to the invention, the connector preferably comprises mechanical fixing elements which are fixed to at least one edge of the extended region of the electrically conductive connector.

According to another embodiment of the present invention, the vehicle or the building provided with an assembly comprising an antenna according to the present invention may be equipped with a repeater system. A repeater system typically comprises: an antenna positioned outside of the building or the vehicle, that can communicate with a base station of the network, an antenna positioned inside of the building or the vehicle, that can communicate with a user terminal, retransmission means provided to act as the interface between the antenna, by retransmitting (with the possibility of amplifying and regenerating) the signals received by one of the antenna destined for the other antenna. It may be understood that such a repeater system permits the network cover to be extended to the inside of the building or the vehicle, so that the users inside of the building or the vehicle may have a good network cover.

1. An assembly comprising:
a two part bidimensional antenna for high frequency communication,
a data transmission coaxial cable with a central pin and a shield,
means for connecting the central pin and the shield of the cable to the two parts of the antenna, the two parts of the antenna being printed on a glazing panel, and
an electrical component selected from the group consisting of a resistor, a capacitor and an inductance, bridging the two parts of the antenna for controlling a connection between the cable and the antenna.

2. The system according to claim 1, wherein the electrical component is an electric resistor.

3. The system according to claim 2, wherein the resistor comprises a material in ceramic or a bridge of poor electrical conductivity.

4. The system according to claim 1, wherein the electrical component comprises a resistor, a capacitor and an inductance.

5. The system according to claim 1, wherein the antenna comprises at least 95% of silver and/or copper.

6. A method comprising, controlling an electric connection between a coaxial cable and a wideband antenna with an electric resistor.

7. The method of claim 5, wherein the electric resistor comprises a material in ceramic or a bridge of poor electrical conductivity.

8. The method of claim 6, wherein the wideband antenna is printed on a glazing surface.

9. An assembly comprising:
a long term evolution two part bidimensional antenna for HF and WB communication, to be connected to a data transmission coaxial cable, with a central pin and a shield to be connected to the two parts of the antenna, the two parts of the antenna being printed on a glazing panel, and
an electrical component selected from the group consisting of a resistor, a capacitor and an inductance, bridging the two parts of the antenna for controlling the connection between the cable and the antenna.

10. An assembly according to claim 9, wherein the electrical component comprises a resistor, a capacitor and an inductance.
